(19) United States
(12) Patent Application Publication
(10) Pub. No.: US 2008/0302255 A1
(43) Pub. Date: Dec. 11, 2008

(54) Method and a Device in Die-Cutting, and a Die-Cutting Press

(75) Inventor: Pekka Koivukunnas, Jarvenpaa (FI)

Correspondence Address: VENABLE LLP, P.O. BOX 34385, WASHINGTON, DC, 20043-9998, US

(73) Assignee: Avantone Oy, Tampere (FI)

(21) Appl. No.: 11/795,415

(22) PCT Filed: Jan. 17, 2006
(86) PCT No.: PCT/FI06/50025

§ 371 Date: May 7, 2008

(30) Foreign Application Priority Data
Jan. 17, 2005 (FI) 20055022

(51) Int. Cl. B41F 19/02

(52) U.S. Cl. 101/27

(57) ABSTRACT

A method and a device for producing a diffractive microstructured area on the surface layer of a substrate by embossing. The device includes a die-cutting press that includes a press member and a backing member and at least one die-cutting tool arranged for die-cutting the substrate placed between the press member and the backing member. The press member and/or the backing member is provided with at least embossing pattern corresponding to the microstructured area, against which pattern the substrate is pressed during the embossing, when the substrate is introduced between the press member and the backing member for the embossing. A method for converting a die-cutting press to a die-cutting and embossing device for producing a diffractive microstructured area on the surface layer of a substrate by embossing, wherein the press member and/or the backing member of the die-cutting press is provided with at least one embossing pattern corresponding to the microstructured area for embossing.

The invention relates to a device according to the preamble of claim 1 for producing a diffractive microstructured area on the surface layer of a substrate by embossing. The invention also relates to a method according to the preamble of claim 6 for producing a diffractive microstructured area on the surface layer of a substrate by embossing in a die-cutting press. The invention also relates to a method according to the preamble of claim 12 for converting a die-cutting press to a die-cutting and embossing device for producing a diffractive microstructured area on the surface layer of a substrate by embossing.

Hot foil stamping is a known printing process for transferring patterns and text onto a substrate, such as paper or cardboard. The printing ink transferred onto the substrate may be based on, for example, pigment, metal or plastic. The printing ink is provided on a printing foil, and the carrier used is a polyester-based foil that is normally in the form of a roll. The printing ink layer and the other layers on the printing foil are detached in the printing process from the foil used as a carrier onto the substrate.

The above-mentioned technique is also used for transferring holograms and diffractive elements to a product, wherein examples to be mentioned include various credit cards, labels, banknotes, passports, and the covers of magazines or books. The holograms and diffractive elements give a desired optical effect that can be used, for example, to authenticate the product. The holograms or diffractive elements have been placed in advance onto the foil, from which they are transferred to the product. Document US 2001/0013282 A1 discloses a method and a device for the production of holographic labels on a continuous band.

For the printing process, a press is required, by which the hologram or diffractive element is transferred onto the substrate. The press presses the foil and the substrate against each other by using a heated press member. During the compression, the foil is pressed between the substrate and the press member. The press member used is, for example, a rotating roll. The substrate is supported against a backing member, wherein the substrate and the foil are pressed together between the press member and the backing member. By the pressing force and the heat, the different layers of the printing foil are transferred from the film onto the surface of the substrate and are attached to the substrate. As a result of the process, the hologram or the diffractive element is transferred onto the substrate. Typically, the backing member is flat and does not comprise elevated patterns. Examples of the device and the process are described, for example, in the documents U.S. Pat. No. 6,223,799, U.S. Pat. No. 5,520,763, U.S. Pat. No. 6,387,201, and U.S. Pat. No. 5,618,378.

An essential part of the foil stamping press is a winding device which comprises a reel on which the foil is stored and from which the foil is introduced, for example, between rolls or corresponding clamping jaws or means for the stamping. In a corresponding manner, the foil, used as a carrier and typically based on polyester, and the layers remaining on the foil are wound onto another reel.

In the next step of the process, a product blank, for example a package blank, is made of the substrate and detached from the rest of the material by die cutting. The operation is performed in a separate die cutting press. At the same stage, it is possible to provide the material of the package blank with the necessary creasings, by means of which the package blank can be folded up or which locations will be provided with other folds of the products. A sheet-like substrate must often be cut to its final dimension by a die-cutting press and even equipped it with windows. A substrate processed in the form of a continuous web must be cut to product blanks or finished products with a desired length and size. Examples of cutting and/or creasing die-cutting presses and processes are disclosed, for example, in documents U.S. Pat. No. 6,039,101, U.S. Pat. No. 5,555,786, U.S. Pat. No. 4,799,414, and U.S. Pat. No. 4,020,724.

In a die-cutting press of a rotatable type, a cylindrical roll is used as the press member. The press roll is pressed against the surface of a cylindrical backing roll while the rolls are rotating. The substrate is normally supplied as a continuous web in between the rolls, which makes a printing process with a large volume possible. The use of a sheet-like substrate is also possible in some machines.

In a die-cutting press of a planar type, the press member and the backing member are of a flat-bed type, and normally a sheet-like substrate is introduced between them.

Processes with separate hot foil stamping presses and die-cutting presses have required further processing and transfers of the substrate. In particular, processing must be performed in a situation in which the substrate is in the form of separate sheets. However, it is difficult to combine hot foil stamping and, for example, cutting, because the cutting will also cut the foil. Therefore, the cutting has been performed at a separate stage of operation in a die-cutting press.

It is an object of the present invention to create an alternative for holograms or diffractive elements placed on the above-mentioned foil, and simultaneously to make simultaneous die cutting possible.

It is an object of the invention to expand the uses of the die cutting presses. In particular, the uses include the application of die cutting presses in embossing to produce diffractive microstructures on the surface of a substrate. The substrate is a plastic film, or preferably paper or cardboard, for example coated with a lacquer, in the form of either a continuous web or single sheets. By means of the die-cutting press, it is possible to detach a finished product or product blank, for example a package blank, by cutting from the rest of the material during the production of the diffractive microstructure.

To achieve this aim, the device according to the invention is characterized in what will be presented in the attached independent claim 1. The method according to the invention is primarily characterized in what will be presented in the attached independent claim 6. The method according to the invention is primarily characterized in what will be presented in the attached independent claim 12. The other, dependent claims will present some preferred embodiments of the invention.

One feature to be applied in the invention is the fact that the press member of the die-cutting press is also used as an embossing means for producing diffractive microstructures onto the surface of the substrate. The press member suitable for use is planar or cylindrical, for example a roll, and the backing member is the backing member of the die-cutting press, which is a roll or a planar backing member.

In the production of diffractive microstructures, typically an embossing shim made of a nickel-based material is used, which is provided with an embossing pattern and which corresponds to the microstructure to be produced on the surface of the substrate. In the invention, said embossing shim is placed onto the surface of the press member of the die-cutting press, for example by means of a suitable mounting piece, fastener or adhesive.

There is no need to use a foil, a winding machine or a foil feeding machine, which are typical of a foil stamping press, wherein cutting is possible. The embossing is now made directly onto the surface of the substrate.

In the embossing, it is possible to utilize the control device of the die-cutting press that provides the required pressing force. Further, in the embossing, it is possible to utilize the mechanisms of the die-cutting press for feeding the substrate, which are also responsible for guiding the web-like or sheet-like substrate in between the pressing members.

Significant advantages of the invention include easy modification and low investments required, wherein the die-cutting presses already installed in the printing process may be modified for embossing, either on a temporary or a permanent basis. The machine is thus, for example, a die-cutting press which has been installed in the process together with a hot foil stamping press and solely for die-cutting. Now, a hot foil stamping press will not be needed.

The required measures include, for example, the installing of an embossing shim in the press member. It is also possible to use a piece made of metal and equipped with a corresponding embossing pattern, to be fixed onto the surface of the backing member. In the embossing, heating devices are also applied, which have been installed in the die-cutting press and by which the above-mentioned embossing shim can be heated to the required extent.

Now, the combination of die-stamping with the production of diffractive microstructures provides an excellent alternative for reducing the number of work stages and devices required in the process, and holograms or diffractive elements placed on a foil can be replaced by a stamping a diffractive microstructure directly onto the surface of the substrate. The stamping of the diffractive microstructure and the die-cutting of the substrate are performed at the same work stage, wherein it is not necessary to move the substrate. Die-cutting refers particularly to creasing or cutting.

In the following, the invention will be described in more detail with reference to the appended drawings, in which:

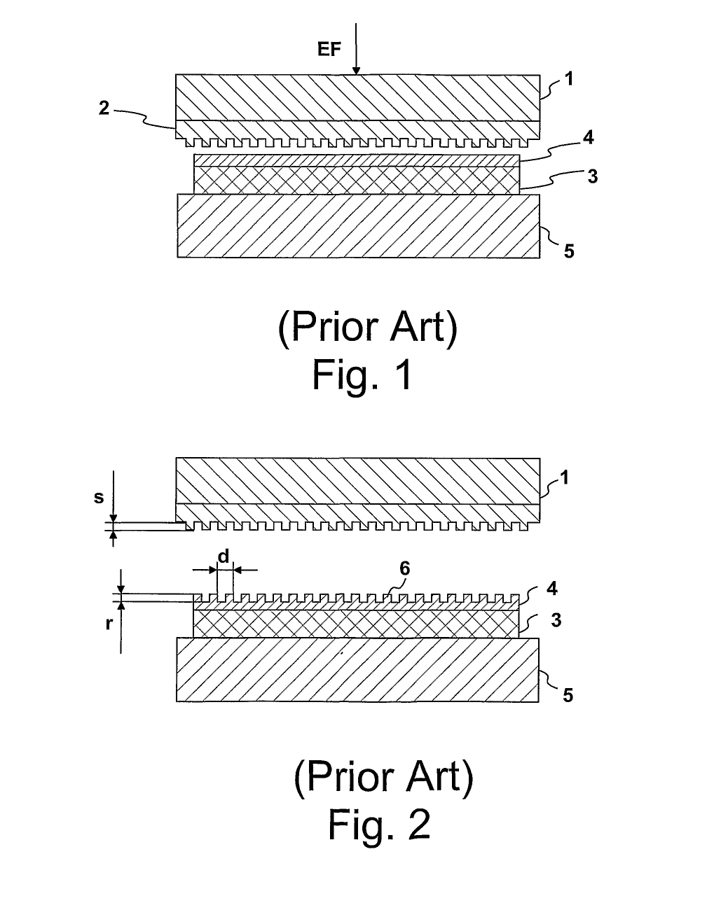

FIG. 1 shows schematically the production of a diffractive microstructured area on the surface layer of a substrate by means of embossing,

FIG. 2 shows schematically an embossing member, a backing member, as well as a bare diffractive microstructured area produced on the surface layer of the substrate by embossing,

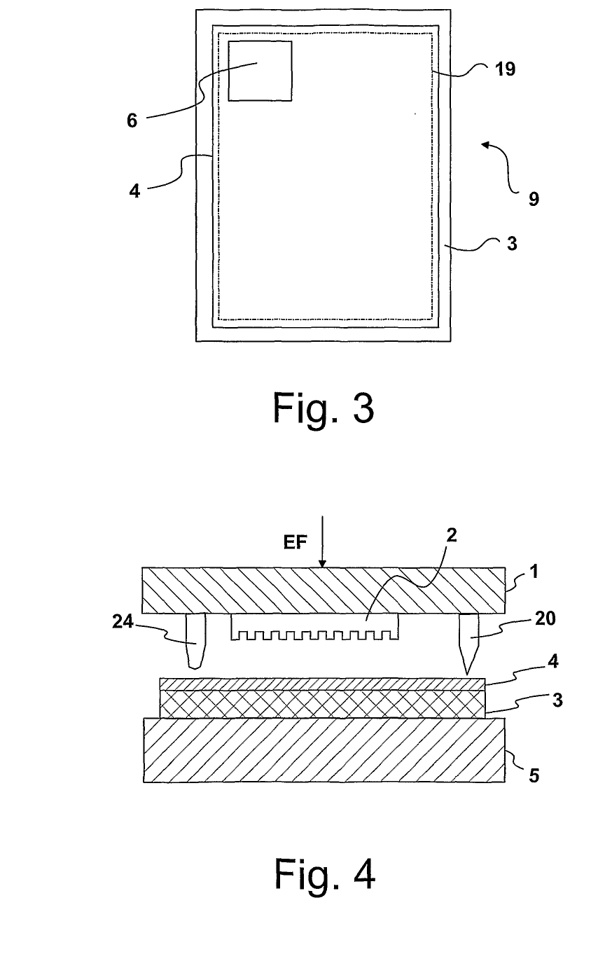

FIG. 3 shows schematically a product with a diffractive microstructured area,

FIG. 4 shows schematically the production of a diffractive microstructured area according to one embodiment, and simultaneous die-cutting,

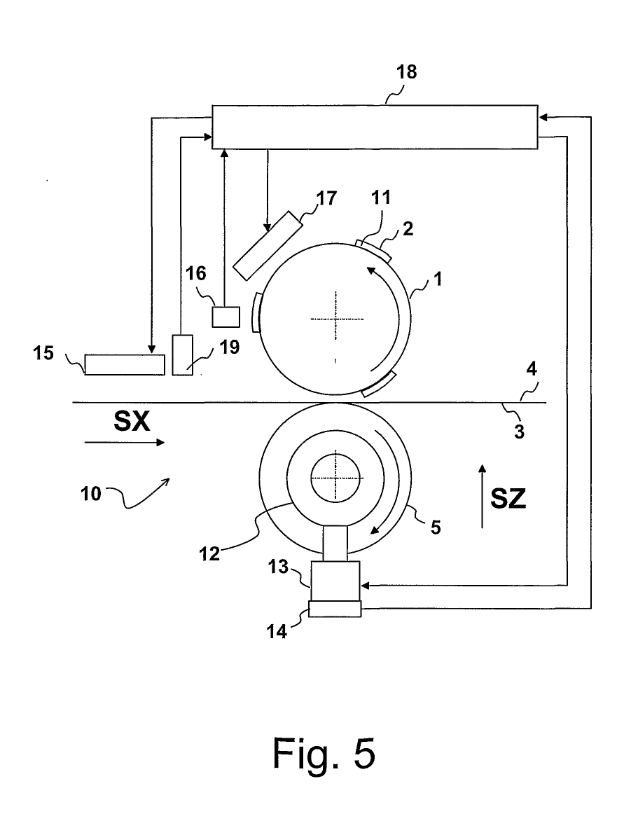

FIG. 5 shows a die-cutting press according to an embodiment of the invention,

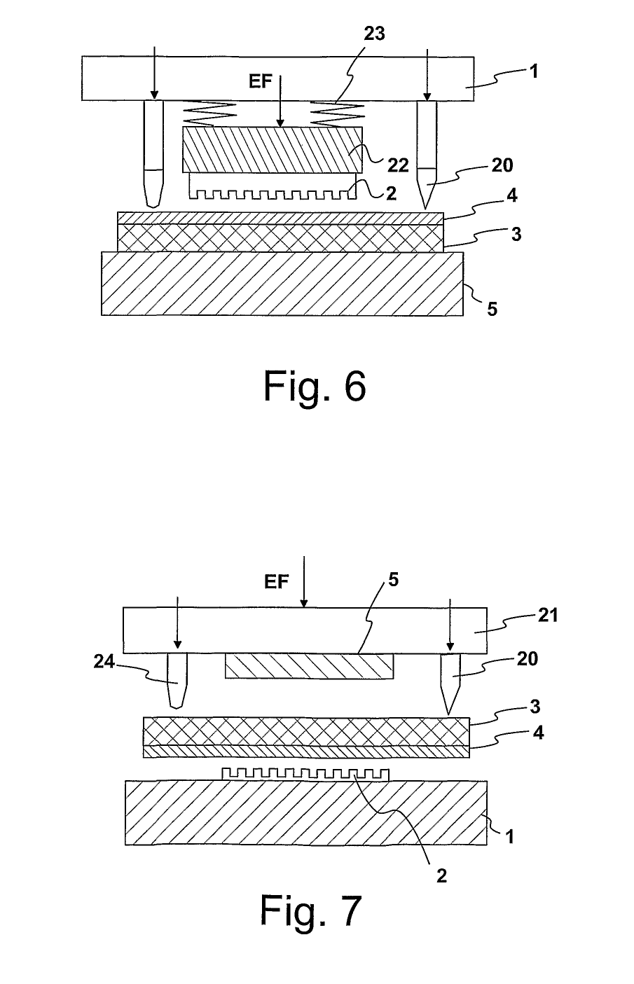

FIG. 6 shows schematically the production of a diffractive microstructured area according to a second embodiment, and simultaneous die-cutting, and

FIG. 7 shows schematically the production of a diffractive microstructured area according to a third embodiment, and simultaneous die-cutting.

As shown in FIG. 5, a product 9 can be provided with one or more microstructured areas 6 having diffractive microstructures, for example for the visual effect produced by them, or for authenticating the product.

The diffractive microstructures can be produced on the surface of a substrate by embossing. The substrate may be provided with a suitable lacquer coating. In the embossing process, the coated substrate is pressed between an embossing member and a backing member. The surface of the embossing member comprises an embossing pattern corresponding to the microstructure. The backing member supports the substrate from the back side during the embossing process in such a way that a sufficient pressure, so-called embossing pressure may be exerted on the substrate, to process the coating to comply with the embossing pattern of the embossing member. For the shaping of the surface of the substrate, it is advantageous to plasticize the surface by heating. In this context, the temperature of the surface of the substrate during the embossing process is called the embossing temperature, and the pressure exerted on the surface layer of the substrate is called the embossing pressure.

Document U.S. Pat. No. 4,923,858 discloses a method for producing a diffractive microstructure on the surface of a paper coated with a thermoplastic material. The coating is provided with the microstructure by means of a heated embossing roll.

The height of the embossing patterns in the microstructured area to be formed is typically a quarter of the wavelength of light, i.e. typically 100 to 200 nanometers. The microstructured area is bare, and it is used as such in the product, without any transparent protective layers. Furthermore, the microstructured area is not coated with a thin metal film that is normally included before adding a protective layer. In some applications, the protection implemented with a transparent protective layer is unnecessarily efficient and expensive in view of the intended service life of the product. Similarly, a protection implemented with a metal film and/or a transparent protective layer would be too expensive with respect to the price of the product.

With reference to FIG. 1, the embossing member 1 is subjected to an embossing force EF. The surface of the embossing shim 2 fixed to the embossing member 1 exerts a corresponding embossing pressure on the surface layer 4 of the substrate 3, local or spatial differences in the embossing pressure generating a local material flow and/or compression on the surface layer 4, wherein the surface layer 4 is processed to correspond to the embossed surface of the embossing shim 2. During the embossing procedure, the substrate 3 is supported by means of a backing member 5.

The substrate 3 may be, for example, paper, cardboard or plastic. In FIG. 1, the substrate has the form of a sheet and a size of almost the size of the embossing shim 2, but the substrate may also be in the form of a web and the embossing shim 2 may be significantly smaller than the substrate. Instead of the embossing shim 2, it is possible to use a piece made of metal and equipped with an embossing. The embossing member may also consist of said piece alone. The surface layer 4 consists of, for example, a thermoplastic material, such as a polyvinyl chloride or polycarbonate plastic, whose viscosity is reduced at a high temperature. The surface layer 4 may also consist of an epoxy resin or a UV curable lacquer. The microstructure may also be embossed in printing ink. The substrate 3 and its surface layer 4 may also consist of the same material.

In FIG. 1, the surface of the embossing member 1 is e.g. an embossing shim 2 made of a nickel-based material, provided by optical and electrolytic methods with embossings corresponding to the desired microstructure. A method for manufacturing the embossing shim 2, provided with an embossing pattern and being suitable for use on the surface of the embossing member 1, is described, for example, in document U.S. Pat. No. 3,950,839. The embossing shim 2 may also be manufactured by methods of electron beam lithography or by using optical exposure in combination with electrochemical deposition.

The surface of the backing member 5 may consist of metal, and its surface is typically flat and without any embossing pattern. To compensate for the roughness of the surfaces, the surface of the backing member 5 may also be resilient, wherein said surface may consist of, for example, an epoxy resin or rubber.

FIG. 2 shows a diffractive microstructure produced on the surface layer of a substrate 3 by the method according to FIG. 1. The shape of the surface of the diffractive microstructured area 6 embossed on the surface layer 4 corresponds to the shape of the surface of the embossing shim 2. The structure is periodical in such a manner that in at least one direction, substantially the same pattern recurs on the surface at intervals of a so-called grating constant d. The value of the grating constant and the orientation of the patterns may vary in different locations of the surface to obtain the desired diffractive effect or holographic pattern. The pattern height r of the produced microstructure is typically in the order of a quarter of the wavelength of light, that is, in the range from 100 to 200 nanometers. However, the pattern height r may be significantly lower than 100 nm, in which case the microstructured area produces a visually weak effect. The pattern height r may also be higher than 200 nm, in which case the wear resistance is improved to some extent.

The maximum pattern height r of the microstructured area 6 is equal to the pattern height s of the surface of the embossing shim 2. If the embossing pressure and/or the embossing temperature is too low, the pattern height r of the microstructured area 6 remains significantly lower than the pattern height s.

The surface layer 6 may comprise several zones covered by a similar or different diffractive microstructure, and a part of the surface layer 6 may be left unembossed.

In the present invention, the press member of the die-cutting press is used as said embossing member 1 for producing the embossing on the surface of the substrate 3. The press member is planar or cylindrical, for example a roll. In the present invention, the backing member of the die-cutting press is used as the backing member 5 for the embossing, against which the substrate 3 is supported. The backing member is a planar backing member or, for example, a cylindrical roll. The numbering used above is also applied for the die-cutting press 10 and its press member 1 and backing member 5 in FIG. 5.

FIG. 5 shows a die-cutting press or device 10 according to one embodiment of the invention, which is used not only for die-cutting but also for providing a web-like substrate 3 with an embossed pattern, preferably a diffractive microstructured area. The device is of a rotatable type, but the same principles may also be applied in a device with a planar press member. The same principles also apply to a device of a planar type.

The device 10 comprises a press member 1 and a backing member 5 which are rotatable rolls. The backing roll 5 is pressed against the press roll 1 in a direction SZ. The press roll 1 and/or the backing roll 5 are rotated by means of suitable rotating mechanisms, and the sub-strate 3 moves in a direction SX, being pressed between the press roll 1 and the backing roll 5. In the presented example, an embossing shim 2 is used, fixed to the press roll 1 by means of a suitable fastener 11 or a fastening. Alternatively, it is possible to use an embossing piece whose surface contains elevated portions for producing microstructured areas. Said pieces are fixed to the press roll 1 by means of a suitable fixing method.

In one embodiment of the die-cutting press, the embossing pressure exerted by the embossing roll 1 and the backing roll 5 on the surface layer 4 of the substrate is adjusted by means of two actuators 13 attached to the bearings 12 of the backing roll 5, which actuators may be for example hydraulic or pneumatic cylinders. The actuators 13 may also be mechanical or electromechanical power generating devices, and they may also be manually adjustable. In connection with the cylinders 13 there are sensors 14 monitoring the die-cutting and embossing force, i.e. indirectly the embossing pressure as well.

The embossing temperature may be controlled by adjusting the power of infrared heaters 15 heating the surface layer 4 of the substrate 3 and/or by adjusting the power of inductive elements 17 heating the press roll 1. Other heating devices may also be applied in the heating. The temperatures are monitored, for example, by pyrometric measuring devices 16 and 19. In some embodiments, the press roll 1 is heated internally, wherein the heating may also be based on a heat transfer medium, for example oil, circulating in the roll 1. The device 10 may also comprise inductive heaters, or auxiliary rolls heated by electricity or by a heat transfer medium. The press roll may comprise thermoelements and pressure sensors for monitoring the pressure and the temperature.

A control unit 18 for the device 10 adjusts the values of the temperatures, pressure and the rotating speed of the rolls on the basis of measuring signals from at least the sensors 16 and 14. If required, the control unit 18 also communicates with other processes simultaneously in operation.

FIG. 3 shows a finished product 9 comprising at least a substrate 3, a substrate surface layer 4, and at least one microstructured area 6 produced on the surface layer 4. The product 9, the substrate 3 and the surface layer 4 may also be integrated and may consist of the same material throughout, for example of plastic. The substrate 3 and its surface layer 4 are preferably made of a flexible material, and their total thickness is preferably in the range from 0.05 to 3 mm.

The product 9 may also be, for example, a product brochure comprising a diffractive microstructured area 6 giving a visual effect. Said brochure may consist of, for example, lacquered paper. The product 9 may also be e.g. a product package whose surface comprises a diffractive microstructured area 6 producing a visual effect. In the die cutting, the product 9 is, for example, cut to its correct size, which is illustrated by a cutting line 19 in FIG. 3.

According to one embodiment, the product of FIG. 3 is a package blank, from which the actual package is formed, wherein the package blank must be cut off a continuous band or a larger sheet. For that purpose, FIG. 4 shows a die-cutting member 1, which is in this case equipped with an embossing shim 2 in addition to die-cutting tools 20 and 24. The die-cutting tool 20 comprises a cutting blade for cutting or punching the substrate 3 to form a cut edge or a line for tearing. The die-cutting tool 24 is a creasing edge that presses a recess onto the surface of the substrate to form a bend in the finished package.

As shown in FIG. 4, the die-cutting and the embossing take place simultaneously during the movement of the embossing member 1. The principles shown in FIGS. 4, 6 and 7 are applicable for die-cutting presses of both the rotating type and the planar type. In FIG. 6, the die-cutting member 1 is also equipped, by means of springs 23, with an embossing shim 2, for example via a suitable support 22. The die-cutting tool 20 is fixed to the die-cutting member 1, possibly by means of a suitable attachment. The die-cutting tool 20, which is a cutting blade, penetrates the substrate 3 when pressed against the backing member 5.

In the embodiments of FIGS. 4, 6 and 7, the embossing and die-cutting take place substantially simultaneously, during the same work stage, wherein the removal of the substrate 3 from between the die-cutting member 1 and the backing member 5 will not be needed for the embossing. However, the movements of the die-cutting means 1 and the embossing shim 2, or the like, may also take place at different times but at the same work stage, as in the embodiment shown in FIG. 6, depending on the apparatus used.

FIG. 7 shows a principle in which the die-cutting tool 20 is on the opposite side of the substrate 3 with respect to the die-cutting member 1. The backing means 5 is possibly equipped with a fastener 21 which moves independently in relation to the die-cutting member 1, and a suitable die-cutting force is exerted on it. The backing member 5 and the fastener 21 may also be separate, the fastener 21 may be attached to the backing member 5, or they may constitute an integrated backing member. The die-cutting tool 20, which is a cutting blade, penetrates the substrate 3 when it is pressed against the backing member of the die cutting that is, in this example, the embossing member 1.

In the embodiments shown in FIGS. 4, 6 and 7, the more precise dimensioning of the members and the timing of the operation are selected according to the requirements of each process in question. It will depend on the die-cutting press to be modified whether it is an embodiment of FIG. 4, 6 or 7, or more precisely a device of a die-cutting press of another type, which is applied according to the invention for embossing and die-cutting in combination. Furthermore, in some devices, the part 1 of FIG. 7 may be called a backing member and the combination of parts 20 and 24 (together with the fastener 21) a die-cutting member. Furthermore, it should be noted that the embossing shim 2 may also be connected to the backing member 5, for example in the embodiments of FIGS. 6 and 7. In this way, embossing may be performed on both sides of the substrate 3.

The invention is not limited solely to the embodiments presented above in the description and drawings, but it may vary within the scope of the appended claims.

1. A device for producing a diffractive microstructured area on a surface layer of a substrate by embossing, the device comprising:
a die-cutting press comprising a press member and a backing member, wherein the press member and/or the backing member comprises at least one embossing pattern corresponding to said diffractive microstructured area, against which the substrate is pressed during the embossing, when said substrate is introduced between said press member and said backing member for die cutting;
at least one die-cutting tool arranged for die-cutting of the substrate placed between said press member and said backing member, and;
at least one heater for heating said press member and/or said backing member.

2. The device according to claim 1, further comprising:
at least one embossing shim comprising said embossing pattern, wherein the at least one embossing shim is fixed to said press member and/or said backing member.

3. The device according to claim 1, further comprising:
at least one heater for heating said substrate.

4. The device according to claim 1, further comprising:
a die-cutting tool arranged for die-cutting said substrate which is introduced between said press member and said backing member for the embossing.

5. The device according to claim 1, wherein the die-cutting tool is a creasing edge arranged for creasing said substrate which is introduced between said press member and said backing member for the embossing.

6. A method for producing a diffractive microstructured area on a surface layer of a substrate by embossing in a die-cutting press comprising a press member and a backing member and at least one die-cutting tool arranged for die-cutting of the substrate placed between said press member and said backing member, wherein the press member and/or the backing member of the die-cutting press is provided with at least one embossing pattern corresponding to said diffractive microstructured area, the method comprising:
heating said press member and/or said backing member, and
keeping the substrate between said press member and said backing member for both embossing and die cutting.

7. The method according to claim 6, further comprising:
using at least one embossing shim fixed to said press member and/or said backing member for the embossing.

8. The method according to claim 6, further comprising:
heating said press member and/or said backing member by means of heaters.

9. The method according to claim 6, wherein said embossing pattern is pressed directly against said substrate during the embossing.

10. The method according to claim 6, further comprising:
using a backing member with a flat surface.

11. The method according to claim 6, further comprising:
using a die-cutting tool arranged to cut said substrate, when said substrate is placed between said press member and said backing member for the embossing.

12. A method for converting a die-cutting press to a die-cutting and embossing press for producing a diffractive microstructured area on the surface layer of a substrate by embossing, which die-cutting press comprises a press member and a backing member and at least one die-cutting tool arranged for the die-cutting of the substrate placed between said press member and said backing member, the method comprising:
providing the die-cutting press with at least one heater for heating said press member and/or said backing member, and
providing the press member and/or the backing member of the die-cutting press with at least one embossing pattern corresponding to said diffractive microstructured area.

13. The method according to claim 12, further comprising:
fixing at least one embossing shim comprising said embossing pattern to said press member and/or said backing member.

14. The method according to claim 12, further comprising:
providing said die-cutting press with at least one heater for heating said substrate.

15. The method according to claim 12, further comprising:
providing said die-cutting press with at least one die-cutting tool which is a cutting blade and is arranged for die-cutting said substrate placed between said press member and said backing member for the embossing.
